(19) United States
(12) Patent Application Publication
(10) Pub. No.: US 2003/0214073 A1
(43) Pub. Date: Nov. 20, 2003

(54) Hardener for an epoxy resin compound, method for curing an epoxy resin compound, epoxy resin compound, and utilizations thereof

(76) Inventors: Klaus Hohn, Taufkirchen (DE); Wilhelm Hekele, Eggstatt (DE)

Correspondence Address: LERNER AND GREENBERG, P.A., Post Office Box 2480, Hollywood, FL, 33022-2480, US

(21) Appl. No.: 10/426,821

(22) Filed: Apr. 30, 2003

(30) Foreign Application Priority Data
Apr. 30, 2002 (DE) 102 20 952.9

(51) Int. Cl. C08G 59/42; C08L 63/00

(52) U.S. Cl. 264/272.11; 525/113; 525/122

(57) ABSTRACT

A hardener for an epoxy resin includes an accelerator having a tetraalkylphosphonium salt. The tetraalkylphosphonium salt has the following formula:

P(R′, R″, R′″, R″″)₄⁺, X⁻, where

R′, R″, R′″, R″″ are individually-selected alkyls ranging from C₂ to C₂₀,

X⁻ is an anion such as Hal⁻, ClO₄⁻, RCO₂(Ac⁻), MX′₆⁻; where M is P, As, Sb; and X⁻ is Hal⁻.

The hardener, an application thereof in the fabrication of an epoxy resin, the epoxy resin itself, and a method for curing an epoxy resin compound, create a material system that is suitable for the field of optoelectronics.

### BACKGROUND OF THE INVENTION

1. Field of the Invention

The invention relates to a hardener for an epoxy resin compound, a method for curing an epoxy resin compound, an epoxy resin compound, and instances of application.

Epoxy resin compounds are utilized today in a variety of ways as adhesives. Owing to their advantageous mechanical, thermal and chemical characteristics, epoxy resin compounds are utilized particularly in optoelectronic systems such as transmitting and receiving components of mobile data bus systems, in which the temperature range is particularly important.

The optoelectronic systems in question typically include what is known as a lead frame with several electrical terminals, electronic subcomponents, a thermoplastic housing with an integrated optical window (CAI: Cavity As Interface) for the terminal of an optical fiber, and an optically transparent casting compound.

The casting compound is usually realized as an epoxy resin compound that serves to encapsulate the component and protect the mechanically sensitive electronic components from various mechanical loads, temperature influences, moisture, chemicals and/or, other harmful stresses. With respect to temperature resistance, good short-term behavior (thermoshock resistance, solder resistance, and galvanic bath load) and good long-term behavior (e.g. resistance to climate) are required, particularly at high operating temperatures.

Furthermore, the casting compound should produce a secure connection to the housing material and should serve as an electromagnetic coupling medium for optical data transmission. Therefore, the casting compound should satisfy high requirements with respect to adhesion to thermoplastic materials, metals, semiconductors, and/or ceramic materials, while at the same time, the transmission of optical signals must be guaranteed. For good optical characteristics, the casting compound must be highly transparent, have few flaws (typically streaks, bubbles, microtears, cracks, delamination), and be nonyellowing. The index of refraction of the casting compound must also be adapted to the optical coupling of the light emitting source, a receiving element, and an optical fiber (e.g. a polymer optical fiber POF). For reliable operation in optical signal transmission, the index of refraction must be sufficiently stable over the operating period corresponding to the optical signals. Changes in the index of refraction can be brought about during operation by chemical changes of the capsule mass.

Existing epoxy anhydride casting resins can be utilized given ambient temperatures up to 125° C. at most.

For future high-performance component generations of optoelectronics, specifically in the automotive field, optically stable casting compounds with a higher glass transition temperature (Tg) of the molding material are needed. The age-related yellowing behavior must be improved for utilization in optical data buses.

Waterclear and nonyellowing epoxy anhydride cast resin molding compounds for optoelectronic purposes are achieved exclusively by specific acceleration on the basis of zinc complexes with carboxylic acid ions as ligands. Because the zinc complexes in the hardener components are of low solubility, solutizers are utilized in order to achieve homogeneous hardener components. However, transparent casting resins are achieved only with a relatively high concentration of solutizer. As a result of the high concentration of the solutizer, the glass transition temperature in the molding compound drops below the value required for the application. Furthermore, the risk of yellowing of the molding compound during operation rises.

An accelerator can be added directly to the reaction resin with a solvent. However, there is a high risk of mixing errors owing to the unfavorable mix and viscosity ratios resulting from the small addition and the markedly low viscosity of the accelerator compared to the reaction resin. These mixing errors lead to production yield losses. Furthermore, the organic solvents that are used represent a risk with respect to health, the environment, and safety. The solvents also increase the shrinkage, which causes tears that degrade the mechanical characteristics of the resin.

In addition, potential haze and transparency losses in the cured molding compound can lead to impermissible optical losses due to attenuation or scattering in the optical data transmission.

The hardening—that is to say, the acceleration of the fabrication—of epoxy cast resins with imidazoles, amines, and quaternary ammonium and phosphonium salts leads to yellow molding compounds which experience sharp yellowing during operation above approx. 80° C. The utilization of quaternary phosphonium salts as latent accelerators for one-component epoxy anhydride resin systems is already known. But the known formulations are not suitable for large-batch application in the relevant field, because the required shelf life of the resin components is insufficient, and curing cannot be efficiently performed owing to long curing cycles. The proportion of accelerator is typically between 0.01 and 0.25% by weight relative to the hardener component (see J. D. B. Smith, J. Appl. Polym. Sci., 23, 1385 (1979)).

### SUMMARY OF THE INVENTION

It is accordingly an object of the invention to provide a hardener for an epoxy resin compound, a method for curing an epoxy resin compound, an epoxy resin compound, and utilizations thereof that overcome the hereinafore-mentioned disadvantages of the heretofore-known devices of this general type and that create an epoxy resin molding compound that is suitable for optoelectronic components. The object is achieved by a hardener and a utilization thereof that result in an epoxy resin that is particularly suitable for optoelectronic applications. The object is further achieved by a method for curing an epoxy resin compound and an epoxy resin compound as such, which are particularly suitable for the field of optoelectronics.

The hardener for an epoxy resin compound inventively includes an accelerator containing a tetra-alkylphosphonium salt, or the hardener is formed entirely of a tetra-alkylphosphonium salt. In the latter case, the hardener is formed from entirely of an accelerator, which then can be utilized in a catalytic curing process.

The inventive structure of the tetra-alkylphosphonium salt takes the following form:

P(R′, R″, R′″, R″″)₄⁺X⁻, where

R′, R″, R′″, R″″: alkyl with C₂ to C₂₀,

X⁻: Hal⁻, ClO₄⁻, RCO₂⁻(Ac⁻), MX′₆⁻

M: P, As, Sb

X′: Hal⁻.

The four alkyls R′, R″, R′″, R″″ can have chain lengths that are identical, partly identical, or entirely different. The phosphonium salt can be added as a substance or in solution, for instance an alcohol solution.

Advantageous curing profiles can be achieved with this hardener. The resulting molding compounds are transparent and nonyellowing and have a Tg>140° C., for example. A new hardener system for transparent, nonyellowing epoxy molding compounds has thus been discovered, which is suitable for application in components with high temperatures. That system is particularly suitable for application as a casting compound in optoelectronics and optical data processing, and as a plastic in the eyeglass and jewelry industries. Owing to the low viscosity, typically of less than 200 mPas, the inventive hardeners are also suitable for utilization in color-stable epoxy resin coatings and epoxy resin varnishes, specifically for utilization outdoors under a solar radiation load.

Besides this, epoxy resin formulations with this hardener are particularly suitable as assembly materials or glues in the optics industry and in photonics.

The tetraalkylphosphonium salt is advantageously realized as n-tetrabutylphosphonium salt. It is also advantageous when the tetraalkylphosphonium salt is a chloride, an acetate, or a bromide. It has been demonstrated that a hardener based on tetraalkylphosphonium acetate, after three months in storage at ambient temperature, exhibits negligible changes in reaction behavior, though it manifests slight yellowing. For optical applications, a storage time of one month at ambient temperature can be presumed. Hardeners based on tetraalkylphosphonium bromide do not yellow when stored at ambient temperature and are stable for at least six months when stored at ambient temperature.

In an advantageous embodiment of the inventive hardener, the proportion of the accelerator content in relation to the hardener content is between 0.3 and 5% by weight, and specifically between 0.7 and 3% by weight.

With the objects of the invention in view, there is also provided an epoxy resin compound that is cured with the aid of a hardener. The curing occurs in the range of a 20% surplus or a 20% deficiency of the hardener relative to stoichiometric relations between the epoxy resin component and the hardener.

With the objects of the invention in view, there is also provided an epoxy resin defined as a product by process.

Other features that are considered as characteristic for the invention are set forth in the appended claims.

Although the invention is illustrated and described herein as embodied in a hardener for an epoxy resin compound, a method for curing an epoxy resin compound, an epoxy resin compound, and utilizations thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying examples.

### DESCRIPTION OF THE PREFERRED EMBODIMENTS

The inventive hardener components are composed as follows:

carboxylic acid anhydride: 60 to 99% by weight

acid ester: 0 to 25% by weight

accelerator, thermal initiator: 0.3 to 5% by weight

X⁻=chloride, bromide, acetate

antioxidation agent: 0.3 to 8% by wt. (phosphorous organic, e.g. triphenylphosphite).

Hexahydrophthalic acid anhydride, methylhexahydrophthalic acid anhydride, or mixtures of the two, are utilized as the carboxylic acid anhydride.

The acid ester modifiers are produced by the conversion of monofunctional and multifunctional alcohols, particularly alkanols, polyester alcohols, or polyether alcohols, with the above cited carboxylic acid anhydrides. The acid esters serve for adapting the reactive behavior of the A:B casting compound, reducing the evaporation of potential volatile components of the casting compound in the curing step, and improving the thermomechanical behavior of the molding compound. The ratio A:B stands for the ratio of epoxy resin (A) to hardener (B).

The proportion of acid ester in the hardener equals 5 to 20% by wt. Tetra-n-butylphosphonium salt accelerators (with X⁻=bromide, acetate) are preferably utilized in concentrations between 0.7 and 3.0% by wt. Particularly advantageous storage behavior is achieved with X⁻=bromide in concentrations less than or equal to 3% by wt. These hardener components usually have a shelf life of at least 6 months at ambient temperature. With these hardener components, given temperatures of 40° at maximum, processing periods of the A:B casting compounds of at least 4 hours are usually achieved.

The curing of the epoxy resin components is performed within the range of a 20% excess or a 20% deficiency of hardener relative to stoichiometric relations and occurs thermally at temperatures above 80° C. Optimally stoichiometric A:B relations are preferred.

For example, inventive epoxy resin components are composed as follows:

multifunctional epoxy resin: 20 to 90% by wt. (e.g. bisphenol-A-diglycidylether)

epoxy resin (epoxy novolac type) 10 to 50% by wt.

epoxy resin made of reactive thinner 1 to 10% by wt. (e.g. o-cresol-glycidylether)

alcohol, particularly alkanol, polyester 1 to 10% by wt.

alcohol, polyether alcohol (single or multiple OH-functional)

deaerator (BYK A506, silicone type): 0.1 to 3% by wt.

primer: 0.1 to 3% by wt. (organofunctional alkoxysilane)

coalescing agent: 0.1 to 3% by wt. (F-organic compounds, silicones)

optical brightening agent: 0.01 to 2% by wt. (e.g. blue organic dye dissolved in EP resin)

Depending on the instance of application, the epoxy resin component can contain internal mold release agents (e.g. Tego DF 48, silicone type) in concentrations 1% by wt., diffusor pigments (e.g. CaF₂, TiO₂, SiO₂, Al₂O₃, BaSO₄, etc. or organic pigments) in concentrations 40% by wt., thixotropic agents (e.g. finely dispersed TiO₂, SiO₂, Al₂O₃, finely dispersed silicic acid with or without a surface modifier).

Epoxy resins are advantageously epoxy casting resin formulations that are applicable in a liquid state, for instance glycidylether-type and glycidylester-type mono-, di-, and multi-functional aliphatic and aromatic resins with oxirane functions, cycloaliphatic resins with oxirane functions, ring peroxidized compounds, and mixtures thereof. The accelerators claimed herein can also be utilized in molding compound applications, namely for fabricating transparent and age-resistant epoxy resin molding compounds (EMC: epoxy molding compounds).

Epoxy casting resin formulas based on bisphenol-A-diglycidylether (>60%), epoxy novolac resin (10%) and selected processing aids—deaerators, primers, optical brighteners—(<5%) are utilized in the following exemplifying embodiments (EP1).

TABLE 1
Composition of Select Hardener Components (% By Wt).

| Hardener | 1 | 2 | 3 | 4 | 5 | 6 | 7 |
|---|---|---|---|---|---|---|---|
| MHHPA | 96 | 97. | 98 | 98. | 98. | 90. | 95.0 |
| SE | — | 5 | — | 5 | 0 | 0 | 4.0 |
| TPP | — | — | — | — | — | 9.0 | — |
| TBPBr | 4.0 | — | — | — | 1.0 | — | 1.0 |
| TBPAc | — | 2.5 | 2.0 | 1.5 | 1.0 | 1.0 | — |
| | | — | | — | — | — | |

Abbreviations:
MHHPA: methylhexahydrophthalic acid anhydride
SE: acid ester
TPP: triphenyl phosphate
TBPBr: n-tetrabutylphosphonium bromide (accelerator)
TBPAc: n-tetrabutylphosphonium acetate (accelerator)

In cases 1, 2, 4, 5, 6, and 7, an accelerator based on bromide was utilized in the exemplifying hardener blend; in case 3, the accelerator was based on acetate.

TABLE 2
Resulting Molding Compound Tg
Following Thermal Curing With EP1

| | A:B Mix Ratio | |
|---|---|---|
| Hardener | (Epoxy Resin | Tg |
| Type | to Hardener) | (° C.) |
| 1 | 100:90 | 150 |
| 2 | 100:90 | 146 |
| 2 | 100:100 | 150 |
| 3 | 100:100 | 148 |
| 4 | 100:100 | 149 |
| 5 | 100:100 | 153 |
| 6 | 100:95 | 152 |
| 7 | 100:95 | 155 |

The advantageous effects of the invention on the yellowing behaviour, particularly following thermal aging, can be demonstrated by the color distance. The epoxy resin with select hardeners according to Table 1 is utilized in the following table.

TABLE 3
Color Distance (380 To 770 Nm) After
Storage 6 Months/120° C./Air

| epoxy | | color distance |
|---|---|---|
| resin/ | A:B | (yellowing |
| hardener | mix ratio | behavior) |
| EP1/2 | 100:90 | 3.17 |
| EP1/3 | 100:90 | 1.94 |
| EP1/4 | 100:100 | 4.78 |
| OS2902 A/B | 100:100 | 9.81 |

OS2902 A/B is a thermally curable epoxy anhydride system manufactured by Dexter/Hysol for casting resin applications in the optoelectronics field and serves herein as a reference for evaluating the yellowing behavior.

The independent developments from Table 3 manifest good transparency prior to the thermal aging process, with transmissions between 400 and 800 nm of <90% (approx. 1 mm layer thickness), and exhibit appreciably improved yellowing behavior compared to the known optical casting resin OS2902.

Storage Stability of the Hardeners:

Accelerated storage stability tests of hardener 4 showed only a slight decrease in reaction enthalpy with EP1 from 358 to 353 J/g after 4 weeks in storage at 80° C., and the T peak in DSC measurements remained unchanged at 156° C. In the hardener 3, slight yellowing was detected under these conditions.

Pot Life of EP1 and Hardener 1 (100:100) at 40° C. (100 g Mass):

viscosity at 25° C:

| | |
|---|---|
| t = 0 h | 590 mPas |
| t = 4.5 | 1030 mPas |
| t = 8 h | 1450 mPas |

Based on the slight increase in the viscosity of the A:B casting compound over time, the pot life of the casting compound EP1/hardener 4 at 40° is usually 4 h—the processing period for lower temperatures is still more favorable.

Thermal Stability, Mechanical Behavior of the Molding Compound, and Adhesion:

TABLE 4
Mechanical behavior (3P bend test
according to DIN 53452 at 25° C.).

| | | | Bending | Flexural | Outer |
|---|---|---|---|---|---|
| Epoxy/ | A:B | Tg | Stress | Modulus | Fiber |
| Hardener | Ratio | (° C.) | (N/mm²) | (N/mm²) | Expansion |
| EP1/3 | 100:100 | 158 | 142 | 2750 | 6 |
| EP1/4 | 100:100 | 158 | 155 | 2840 | 7 |

The selected casting compounds exhibit favorable mechanical behavior, with notable (Tg 158° C.) outer fiber expansions between 6 and 7% in mechanical tests according to DIN 53452. After thermal aging for 6 weeks at 120° C. in air, EP1/hardener 3 retains Tg=158—for EP1/hardener 4, the Tg rises slightly to 160° C. This observation points to mechanical, chemical-structural and thermal stability under temperature load. In shear tests, high adhesive strength values on the order of 40 N/mm² and above were registered for EP1 and hardener 4 on different leadframe coatings.

Cold Water Absorption, (Fully De-Ionized Water, Storage at 23° C., 6 Weeks):

EP1/hardener 3 (100:100):0.8%

EP1/hardener 4 (100:100): 0.8%

The invention is not limited in its embodiment to the cited preferred exemplifying embodiments. Rather, there are a number of imaginable variants that employ the inventive hardener, the inventive method, the epoxy resin compound, and the inventive utilization, even in fundamentally different embodiments.

We claim:

1. A hardener for an epoxy resin compound, comprising an accelerator including a tetraalkylphosphonium salt having a formula:
P(R′, R″, R′″, R″″)₄⁺, X⁻, where
R′, R″, R′″, R″″ are alkyls independently selected from the group consisting of C₂ to C₂₀, and
X⁻ is an anion selected from the group consisting of Hal⁻, ClO₄⁻, RCO₂⁻(Ac⁻), and MX′₆⁻; where M is selected from the group consisting of P, As, Sb; and X⁻ is Hal⁻.

2. The hardener according to claim 1, wherein said tetraalkylphosphonium salt is an n-tetrabutylphosphonium salt.

3. The hardener according to claim 1, wherein said tetraalkylphosphonium salt is coordinated with an anion selected from the group consisting of a chloride, an acetate, and a bromide.

4. The hardener according to claim 1, wherein a proportion of said accelerator relative to the hardener is from 0.3 to 5% by wt.

5. The hardener according to claim 4, wherein said proportion of said accelerator relative to the hardener is from 0.7 to 3% by wt.

6. The hardener according to claim 1, further comprising:
a carboxylic acid anhydride forming from 60 to 99% by wt.;
an acid ester forming from 0 to 25% by wt.;
said accelerator forming from 0.3 to 5% by wt.; and
an antioxidation agent forming from 0.3 to 8% by wt.

7. The hardener according to claim 6, wherein a proportion of said accelerator is from 0.7 to 3.0% by wt.

8. The hardener according to claim 6, wherein said accelerator is an n-tetrabutylphosphonium bromide forming a proportion at most equaling 3.0% by wt.

9. The hardener according to claim 6, wherein said carboxylic acid anhydride is selected from the group consisting of hexahydrophthalic acid anhydride and methylhexahydrophthalic acid anhydride.

10. The hardener according to claim 6, wherein said acid ester is produced by converting a carboxylic acid anhydride with an alcohol.

11. The hardener according to claim 10, wherein said alcohol is monofunctional.

12. The hardener according to claim 10, wherein said alcohol is multifunctional.

13. The hardener according to claim 10, wherein said alcohol is selected from the group consisting of an alkanol, a polyester alcohol, and a polyether alcohol.

14. The hardener according to claim 6, wherein a proportion of said acid ester is between 5 and 20% by wt.

15. The hardener according to claim 6, wherein said antioxidation agent is a phosphoric organic compound.

16. The hardener according to claim 15, wherein said phosphoric organic compound is triphenylphosphite.

17. A hardener for an epoxy resin compound, comprising an accelerator consisting of a tetraalkylphosphonium salt having a formula:
P(R′, R″, R′″, R″″)₄⁺, X⁻, where
R′, R″, R′″, R″″ are alkyls independently selected from the group consisting of C₂ to C₂₀, and
X⁻ is an anion selected from the group consisting of Hal⁻, ClO₄⁻, RCO₂⁻(Ac⁻), and MX′₆⁻; where M is selected from the group consisting of P, As, Sb; and X⁻ is Hal⁻.

18. A method for curing an epoxy resin compound, which comprises:
applying a hardener according to claim 1 to an epoxy resin component; and
maintaining a stoichiometric relationship of the hardener to the epoxy resin component between a 20% surplus and a 20% deficiency while curing.

19. The method according to claim 18, which further comprises adding the tetraalkylphosphonium salt as a substance.

20. The method according to claim 18, which further comprises adding the tetraalkylphosphonium salt as a solution.

21. The method according to claim 20, where the solution is an alcoholic solution.

22. The method according to claim 18, which further comprises maintaining a nearly equal stoichiometric ration of the epoxy resin to the hardener while curing.

23. The method according to claim 18, wherein the epoxy resin component is selected from the group consisting of a monofunctional epoxy compound, a bifunctional epoxy compound, a multifunctional aliphatic compound, a cycloaliphatic epoxy compound, and an aromatic epoxy compound.

24. The method according to claim 23, wherein the epoxy resin component has an oxirane function selected from the group consisting of a glycidylether type and a glycidylester type.

25. The method according to claim 18, wherein the epoxy resin compound is selected from the group consisting of a bisphenol-A-diglycidylether and an epoxy novolac resin.

26. The method according to claim 25, wherein the epoxy novolac resin is an epoxy cresol novolac.

27. The method according to claim 18, which further comprises including in the epoxy resin:
a multifunctional epoxy resin forming 20 to 90% by wt.;
an epoxy resin forming 10 to 50% by wt.;
an epoxy resin from reactive thinner forming 1 to 10% by wt.;
alcohol forming 1 to 10% by wt.;
deaerator forming from 0.1 to 3% by wt.;
primer forming from 0.1 to 3% by wt.;
coalescing agent forming from 0.1 to 3% by wt.; and
an optical brightener forming from 0.01 to 20% by wt.

28. The method according to claim 27, wherein the multifunctional epoxy resin is bisphenol-A-diglycidylether.

29. The method according to claim 27, wherein the epoxy resin forming is an epoxy novolac type resin.

30. The method according to claim 27, wherein the epoxy resin from reactive thinner is o-cresol-glycidylether.

31. The method according to claim 27, wherein the alcohol is selected from the group consisting of an alkanol, a polyester alcohol, and a polyether alcohol.

32. The method according to claim 27, wherein the alcohol is single OH-functional.

33. The method according to claim 27, wherein the alcohol is multiple OH-functional.

34. The method according to claim 27, wherein the deaerator is a BYK A506 silicone type.

35. The method according to claim 27, wherein the primer is organofunctional alkoxysilane.

36. The method according to claim 27, wherein the coalescing agent is selected from the group consisting of an F-organic compound and a silicone.

37. The method according to claim 27, wherein the optical brightener is a blue organic dye dissolved in EP resin.

38. The method according to claim 18, wherein the epoxy resin component includes an internal mold release agent in concentrations at most equaling 1% by wt.

39. The method according to claim 38, wherein the internal mold release is Tego DF48.

40. The method according to claim 18, wherein the epoxy resin component includes a diffusor pigment selected from the group consisting of CaF₂, TiO₂, SiO₂, Al₂O₃, and BaSO₃.

41. The method according to claim 18, wherein the epoxy resin component includes an organic pigment with concentrations less than 40% by weight.

42. The method according to claim 18, wherein the epoxy resin component includes a thixotropic agent.

43. The method according to claim 42, wherein the thixotropic agent is selected from the group consisting of finely dispersed TiO₂, SiO₂, Al₂O₃, and finely dispersed silicic acid.

44. The method according to claim 43, which further comprises including a surface modifier with the thixotropic agent.

45. An epoxy resin fabricated by a method according to claim 18.

46. A method for forming casting compounds, which comprises:
providing a hardener according to claim 1; and
fabricating an A:B casting compound for encapsulating electronic and optoelectronic components by using the hardener.

47. The method according to claim 46, wherein the A:B casting compounds have a Tg>140° C.

48. A method according for fabricating molding compounds, which comprises utilizing a hardener according to claim 1 to form an epoxy resin compound.

49. The method according to claim 48, wherein the epoxy resin compound is transparent and age resistant.

50. A method for fabricating A:B casting compounds, which comprises:
providing a hardener according to claim 1;
fabricating A:B casting compounds for encapsulating electronic and optoelectronic components for utilization at operating temperatures above 120° C. with the hardener.

51. The method according to claim 50, wherein the A:B casting compounds are used in the automotive industry.

52. A method of using epoxy resins outdoors, which comprises utilizing an epoxy resin according to claim 45 outdoors.

53. The method according to claim 52, which further comprises weatherproofing an object by coating the object with the epoxy resin.

54. A method for protecting electronics, which comprises:
providing an epoxy resin according to claim 45; and
covering an electronic component with the epoxy resin.

55. The method according to claim 54, wherein the electronic component is selected from the group consisting of an electronic element, an optoelectronic element, a module, and a component.
